(19) United States
(12) Patent Application Publication
(10) Pub. No.: US 2004/0118300 A1
(43) Pub. Date: Jun. 24, 2004

(54) APPARATUS FOR MEASURING AND DISHING UP FOOD

(76) Inventor: Kisaku Suzuki, Tokyo (JP)

Correspondence Address: ISRAEL GOPSTEIN, Attorney at Law, P.O. Box 9303, Silver Spring, MD, 20916-9303, US

(21) Appl. No.: 10/717,669

(22) Filed: Nov. 21, 2003

(30) Foreign Application Priority Data
Dec. 20, 2002 (JP) 2002-369279

(51) Int. Cl. A47J 9/00; A23L 1/00

(52) U.S. Cl. 99/355; 99/357

(57) ABSTRACT

The present invention has its object to provide a compact apparatus for measuring and dishing up food which is light in weight at low cost, and capable of quickly and accurately dishing up food (cooked rice) of a desired weight in a sufficiently loosened state into a container such as a lunch box and bowl.

An apparatus for measuring and dishing up food in which a food supplying mechanism 21 and a food measuring mechanism 101 are placed to oppose each other at an upper and a lower positions of the dishing-up apparatus main body 1. The food supplying mechanism 21 includes a hopper 22, loosening and supplying means 24 for supplying food a supplied from the hopper while loosening the food, and a shutter 25. Meanwhile, the food measuring mechanism 101 includes a measuring platform 102 and an electronic measuring scale 103, and the food supplying mechanism 21 and the food measuring mechanism 101 are connected via a control device 93. The dishing-up apparatus main body 1 is provided with a plurality of measuring buttons 91 placed in parallel each for each target measurement value.

### BACKGROUND OF THE INVENTION

1. Field of the Invention

The present invention relates to an apparatus for measuring and dishing up food capable of continuously measuring and dishing up a desired amount of cooked rice into containers such as lunch boxes and bowls.

2. Description of the Related Art

An apparatus for measuring and dishing up food capable of automatically measuring and supplying a fixed amount of cooked rice of boxed lunch or rice served with topping in a bowl into containers such as lunch boxes and bowls is conventionally known (for example, refer to Patent Document 1).

[Patent Document 1]

Japanese Patent Laid-Open No. 2002-253840

However, the aforesaid conventional apparatus for dishing up food is constituted of combination of a large number of large-sized components, and accordingly, the apparatus is large-sized as a whole, thus causing the problem of not only requiring a large installation space, but also increasing in cost.

For this reason, the aforesaid conventional apparatus for dishing up food is not suitable as an apparatus for dishing up food capable of being used conveniently in, for example, a shop manufacturing and selling box lunch, a beef bowl (“beef bowl” is a bowl of rice with beef topping) and the like, though the conventional apparatus is suitable for a mass production machine used in a boxed lunch manufacturing factory and the like.

The present invention is made in view of the above conventional problems, and has its object to provide a compact apparatus for measuring and dishing up food, which is light in weight at low cost and capable of quickly and accurately dishing up food of a desired weight in a sufficiently loosened state into a container such as a lunch box and a bowl.

### SUMMARY OF THE INVENTION

In order to attain the above-described object, an apparatus for measuring and dishing up food according to the present invention in claim 1 is an apparatus for measuring and dishing up food in which a food supplying mechanism and a food measuring mechanism are placed to oppose each other at an upper and a lower positions of the dishing-up apparatus main body, characterized in that the food supplying mechanism comprises a hopper, loosening and supplying means for supplying food supplied from the hopper while loosening the food, and a shutter for controlling supply and stop of the food to the measuring mechanism, the food measuring mechanism comprises a measuring platform and an electronic measuring scale, and the aforesaid food supplying mechanism and food measuring mechanism are connected via a control device.

In the invention in claim 1, the food supplying mechanism and the food measuring mechanism are placed to oppose each other at the upper and the lower positions of the dishing-up apparatus main body, whereby the apparatus can sufficiently loosen the food and supply the food of a desired weight into the container placed on the measuring platform of the food measuring mechanism from the food supplying mechanism located over it, namely, the apparatus can dish up the food softly into the container, and can quickly and accurately dish up, and in addition, the apparatus is simple in its entire structure, compact, and light in weight at low cost, and consequently suitable for use in shop manufacturing and selling lunch, shops manufacturing and selling beef bowls, and the like.

In claim 2, the apparatus for measuring and dishing up food is characterized in that the dishing-up apparatus main body is provided with a plurality of measuring buttons placed in parallel each for each target measurement value, and the measuring buttons are connected to the food supplying mechanism via the control device.

In the invention of claim 2, the dishing-up apparatus main body is provided with a plurality of measuring buttons, whereby the food of a desired weight can be easily dished up by only selecting and pressing the button clearly indicating large, middle, small, trade names to which the food is applied, and the like.

### BRIEF DESCRIPTION OF THE DRAWINGS

FIG. 1 is a perspective view of an apparatus for measuring and dishing up food according to the present invention;

FIG. 2 is a front view of the same;

FIG. 3 is a side view of a state in which a lid is opened of the same;

FIG. 4 is a sectional view taken along the arrows A to A in FIG. 3;

FIG. 5 is an exploded perspective view of a food supplying mechanism of the same;

FIG. 6 is a plan view for explaining a food supplying mechanism driving section of the same;

FIG. 7 is a vertical side view showing a food dishing-up operation in progress of the same;

FIG. 8 is a plan view of a shutter in an opened state and a shutter driving section;

FIG. 9 is a side view of the same;

FIG. 10 is a sectional view taken along the arrows B to B in FIG. 8;

FIG. 11 is a side view of the shutter in a closed state and the shutter driving section;

FIG. 12 is a sectional view taken along the arrows B to B in FIG. 8 in the closed state;

FIG. 13 is an explanatory view of a system of the entire food measuring and supplying apparatus; and

FIG. 14 is a flow chart showing operation steps to the completion of dishing-up of food.

### DETAILED DESCRIPTION OF THE PREFERRED EMBODIMENTS

An embodiment of the present invention will be explained in detail below with reference to the drawings.

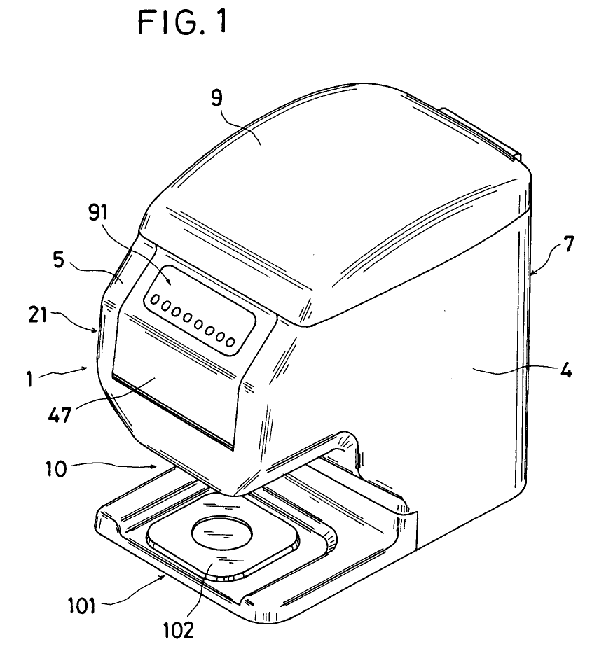

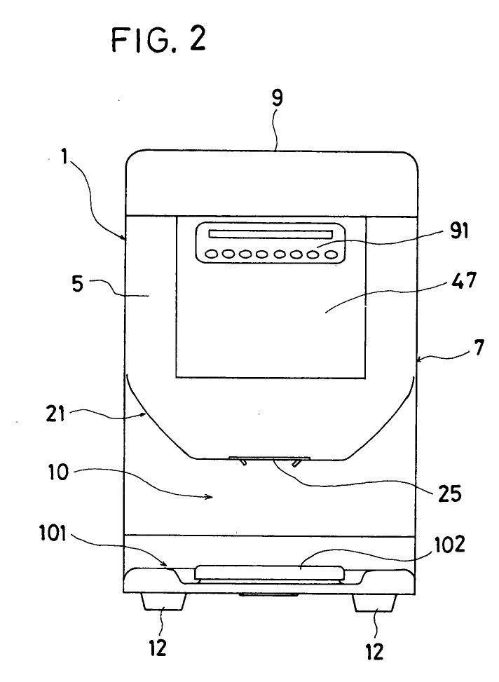

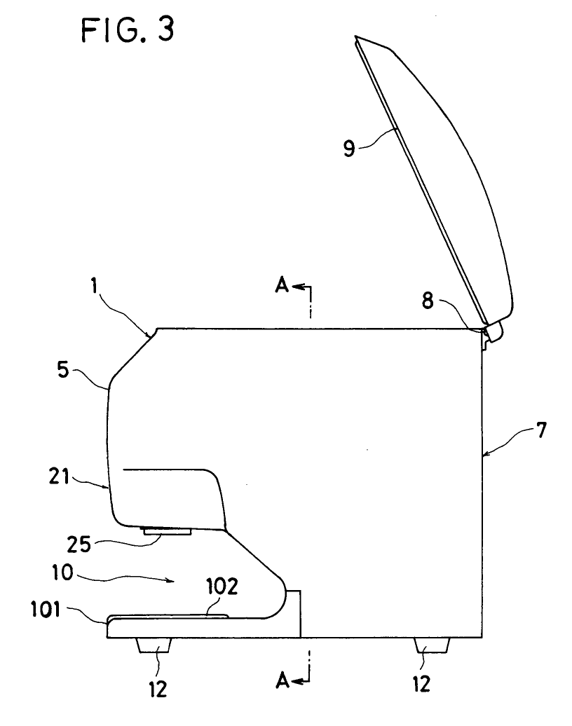

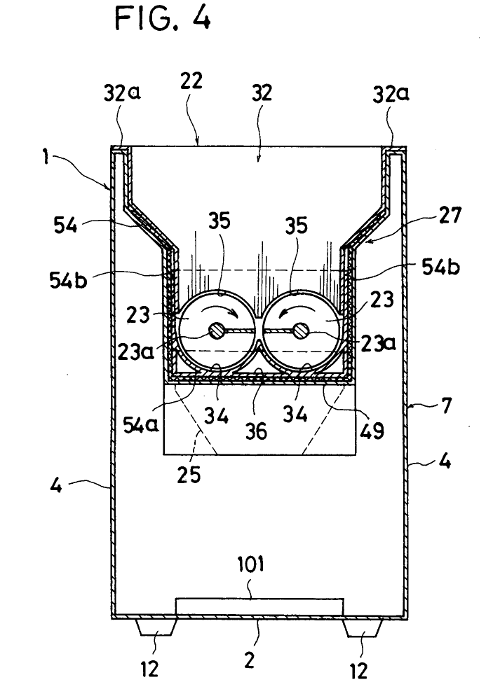

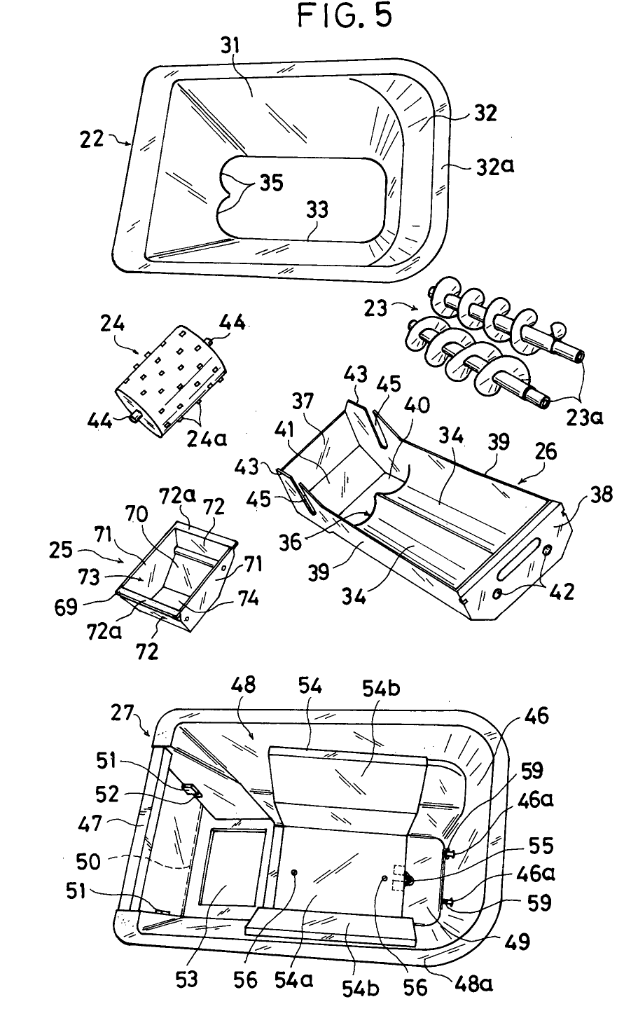

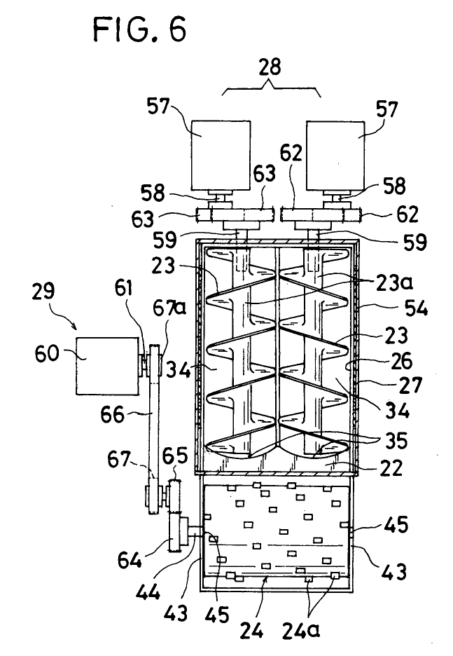

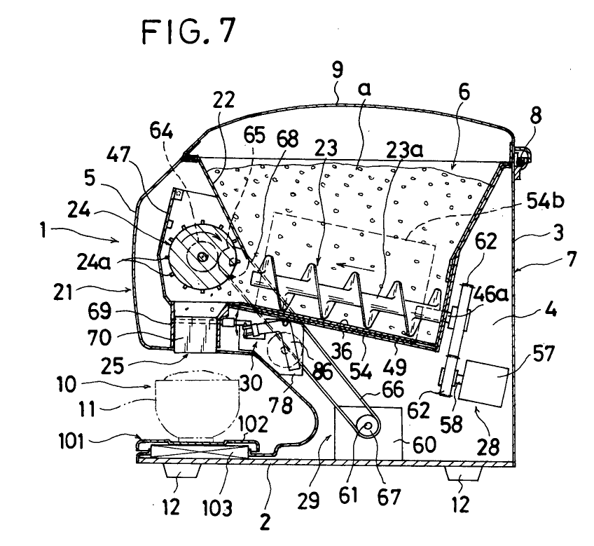

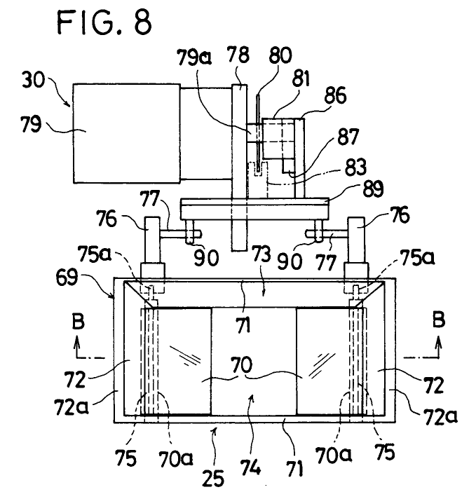

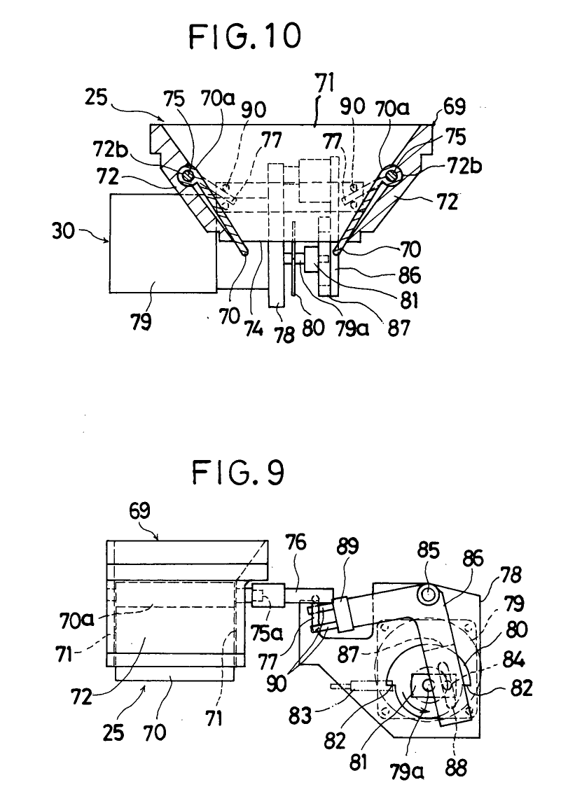

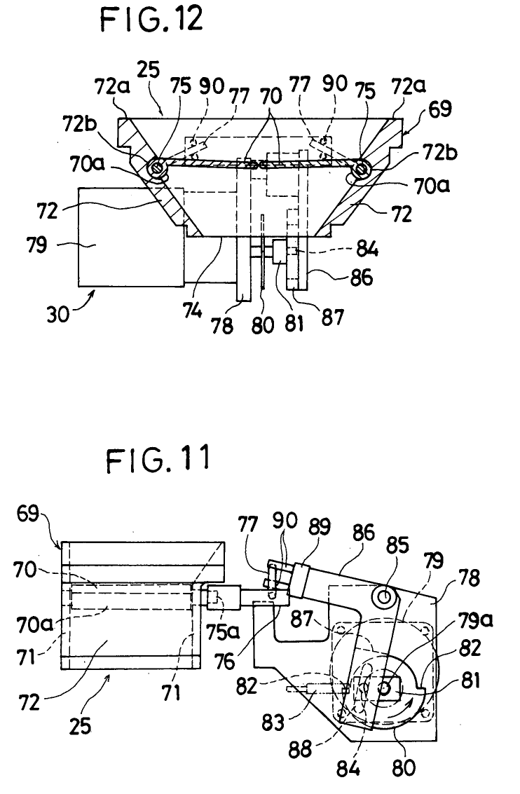

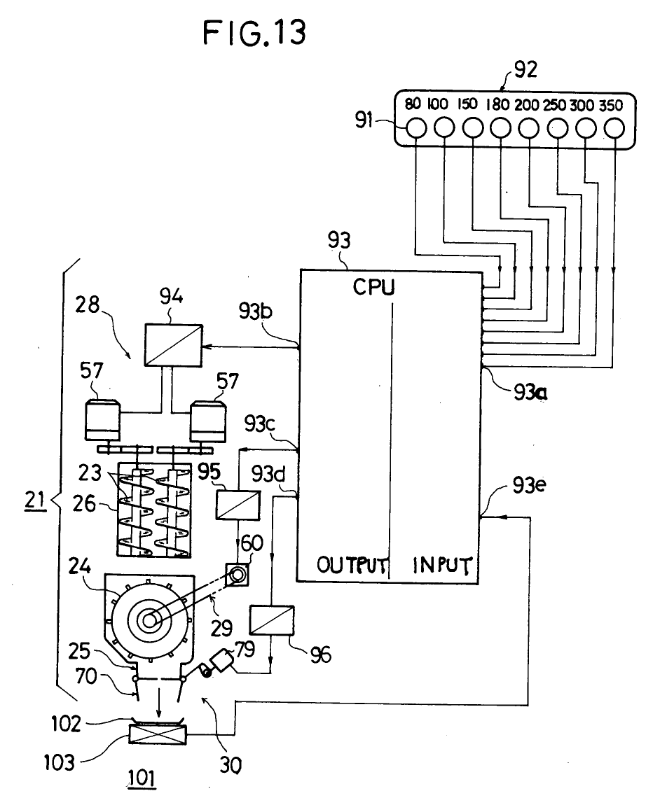

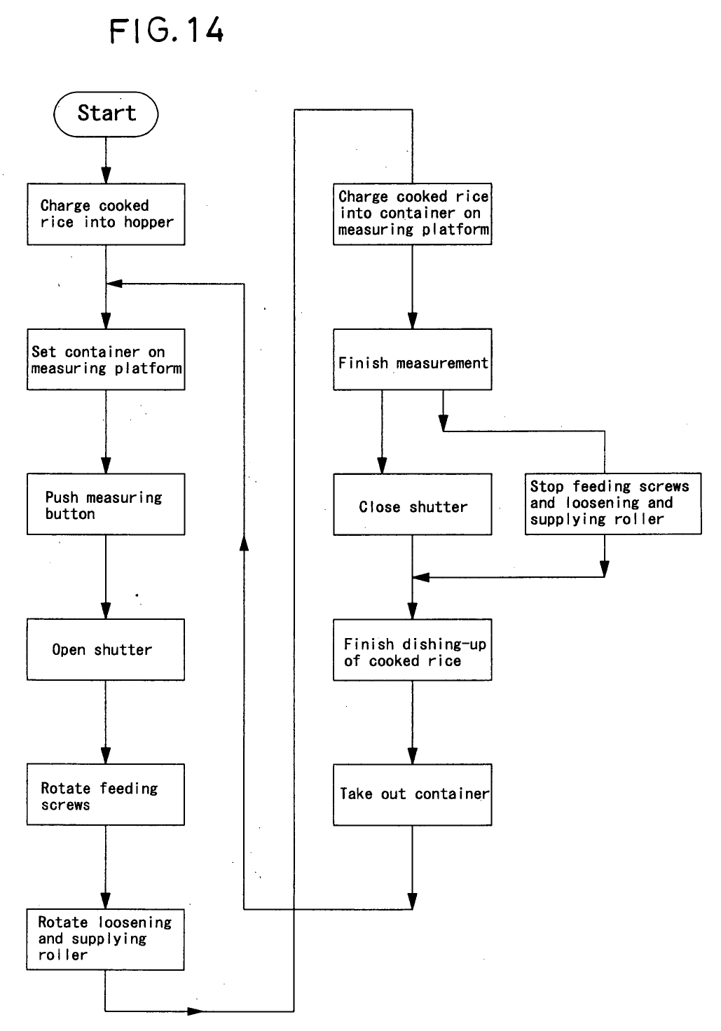

FIG. 1 shows a perspective view of an apparatus for measuring and dishing up food according to the present invention, FIG. 2 shows a front view of the same, FIG. 3 shows a side view of a state in which a lid is opened of the same, FIG. 4 shows a sectional view taken along the arrows A to A in FIG. 3, FIG. 5 shows an exploded perspective view of a food supplying mechanism of the same, FIG. 6 shows a plan view for explaining its driving section, FIG. 7 shows a vertical side view showing a food dishing up operation in progress of the same, FIG. 8 shows a plan view of a shutter in an open state and a shutter driving section, FIG. 9 shows a side view of the same, FIG. 10 shows a sectional view taken along the arrows B-B in FIG. 8, FIG. 11 shows a side view of the shutter in a closed state and the shutter driving section, FIG. 12 shows a sectional view taken along the arrows B-B in FIG. 8 in the closed section, FIG. 13 is an explanatory view of a system of the entire apparatus for measuring and dishing up food, and FIG. 14 is a flow chart showing operation steps to the completion of dishing-up of food.

As shown in FIG. 1 to FIG. 7, the apparatus is constructed by a dishing-up apparatus main body 1, a food supplying mechanism 21 and a food measuring mechanism 101 placed to oppose each other at an upper and a lower positions of the dishing-up apparatus main body 1, as main components.

The dishing-up apparatus main body 1 is constructed as follows.

The dishing-up apparatus main body 1 includes a box body 7 formed by bottom plate 2, a back plate 3, a left and a right side plates 4 and 4, and a front plate 5, with a top part as an opening 6, and a lid 9 for opening and closing the opening 6 of the box body 7, which is connected to an upper end of the back plate 3 via a hinge 8. The front plate 5 of the aforesaid box body 7 is pivotally supported at its upper end to be openable and closable. A recessed portion 10 having a predetermined depth and height is formed under the front plate 5. The recessed portion 10 has a sufficient space for housing a container 11 on the occasion of dishing up food, and at the upper and the lower positions thereof, the food supplying mechanism 21 and the food measuring mechanism 101 are placed to oppose each other.

Reference numeral 12 in the drawing denotes a leg pad provided at an undersurface of the bottom plate 2 of the box body 7.

The food supplying mechanism 21 is constructed as follows.

The food supplying mechanism 21 includes a hopper 22, housing case 26 for housing and fixing each component of two food feeding screws 23 and 23, a drum-shaped food loosening and supplying roller 24 as food loosening and supplying means, and a shutter 25, and a base rack 27 and driving mechanisms 28, 29 and 30.

The hopper 22 is provided with a tapering wall 31 gradually narrowing from an upper side to a lower side, whereby an upper end is made a wide opening 32 and a lower end is made a narrow opening 33. The wide opening 32 is provided with a flange 32a bent outside the opening 32. The narrow opening 33 is formed in such a size as to allow only the food feeding screws 23 and 23 to be exposed which are housed and disposed in housing grooves 34 and 34 each in a substantially semicircular shape of the housing case 26 and cover the other parts. Substantially semicircular notches 35 and 35 are arranged in parallel at a lower edge of a front end of the opening 33 to correspond to the housing grooves 34 and 34 of the housing case 26.

The housing case 26 is formed by a bottom wall 36 on which the above-described substantially semicircular housing grooves 34 and 34 are provided in parallel in a lateral direction on both left and right sides thereof, a front wall 37 and a rear wall 38 vertically provided at a front and a rear ends of the bottom wall 36, and side walls 39 and 39 vertically provided at both left and right ends, with an upper side being opened.

The bottom wall 36 of the housing case 26 has its front end notched to have an opening 40, and on the front wall 37, an inclined portion 41 bent toward the opening 40 is formed at a lower side thereof, while on the rear wall 38, shaft holes 42 for the food feeding screws 23 and 23 are provided at both sides opposing the housing grooves 34 and 34 of the bottom wall 36. The left and the right side walls 39 and 39 are provided with raised portions 43 and 43 at front ends, and at upper ends of the respective raised portions 43 and 43, recessed grooves 45 and 45, which bear support shafts 44 and 44 attachably and detachably, and rotatably at both ends of the food loosening and supplying roller 24, are provided to be opened upward.

The base rack 27 has a space for housing the hopper 22, the housing case 26, the shutter 25 and the like, and is provided with a tapering wall 46 gradually narrowing from an upper side to a lower side at three sides, which are both sides and a rear side, and with a door 47 at a front side, respectively, and thereby an upper end is made a wide opening 48, while a narrow bottom wall 49 is provided at a lower end. The wide opening 48 is provided with a flange 48a bent to an outside of the opening 48.

The door 47 is supported at its lower end by a shaft 50, which is provided to span the front lower ends of the tapering wall 46, so that the door 47, namely, a front side of the base rack 27 is openable and closable in a longitudinal direction. Magnets 51 and 51 are fixedly provided at both ends of an upper portion of an inner side of the door 47, respectively, while attraction plates 52 and 52 made of metal are fixedly provided at the tapering wall 46 opposing the magnets 51 and 51, whereby when the door 47 is closed, the magnets 51 and 51 are attracted to the attraction plates 52 and 52, and the door 47 is prevented from opening outward. This door 47 is opened together with the front plate 5, whereby attaching and detaching, cleaning and the like of the loosening roller 24, the shutter 25 and the like are facilitated. It goes without saying that the means for fixing the door 47 is not limited to the above-descried means.

The bottom wall 49 of the base rack 27 has a rectangular opening 53 at its front end, so that a locking portion 72a of the shutter 25 is detachably and attachably fitted onto the opening 53. A heat insulating plate 54 made of metal, which is bent substantially in a U-shape is provided on an upper surface of the bottom wall 49. A heater 55 is connected to this heat insulating plate 54, a bottom surface portion 54a is fixed to the bottom wall 49 with screws 56, and a whole of the bottom surface portion 54a and both side surface portions 54b and 54b is heated by energizing the heater 55, whereby the base rack 27, the housing case 26, the hopper 22 and the like are warmed to keep the temperature of food (cooked rice) inside.

Assembly of the food supplying mechanism 21 with the above construction is as follows.

First, the shutter 25 is fitted into the opening 53 at the front end of the base rack 27, and next, the housing case 26 is placed on the bottom surface portion 54a of the heat insulating plate 54 placed on the bottom wall 49 of the base rack 27 so that the opening 40 is located directly over the shutter 25.

The two food feeding screws 23 and 23 are faced to the housing grooves 34 and 34 of the housing case 26, and rear ends of respective rotary shafts 23a and 23a are connected to rotary shafts 59 and 59 interlocked with and connected to driving shafts 58 and 58 of motors 57 and 57 as the driving mechanism 28, which are inserted through holes 46a and 46a opened in the rear tapering wall 46 of the base rack 27 and protruded inside. As a result, the food feeding screws 23 and 23 are rotatably supported over the housing grooves 34 and 34 of the housing case 26 with a little clearance therefrom in parallel.

Next, support shafts 44 and 44 at both ends of the food loosening and supplying roller 24 as food loosening and supplying means are engaged in the recessed grooves 45 and 45 provided at the raised portions 43 and 43 at the front ends of the side walls 39 and 39 of the housing case 26, and one of the support shafts 44 is connected to a driving shaft 61 of a motor 60 as the driving mechanism 29, whereby the food loosening and supplying roller 24 is rotatably supported.

The drive mechanism 28 includes the two motors 57 and 57 as already described, and the respective driving shafts 58 and 58 and the rotary shafts 59 and 59 are respectively interlocked with and connected to each other via gears 62, 62, 63 and 63, whereby the two food feeding screws 23 and 23 provided in parallel are rotated in an inward rotating direction respectively. It goes without saying that the two screws can be driven with one motor via an idler gear (not shown).

The driving mechanism 29 includes the one motor 60 as already described, and its driving shaft 61 and the one of the support shafts 44 of the fool loosening and supplying roller 24 are interlocked with and connected to each other via gears 64 and 65, a pulley 67 fixed on the same shaft as the gear 65, a belt 66, and a pulley 67a fixed on the driving shaft 61 of the motor 60, whereby the drum-shaped food loosening and supplying roller 24 as the food loosening and supplying means is rotated in an inward rotating direction as shown by the arrow in FIG. 7.

A number of claws 24a are projectingly provided equidistantly on an outer periphery of the drum-shaped food loosening and supplying roller 24 as the food loosening and supplying means. The food loosening and supplying roller 24 with the claws 24a being projectingly provided thereon is placed so that its rear portion is located at a front side of a food passage hole 68 formed between the notches 35 and 35 provided at the front end of the hopper 22 and upper edges of the front ends of the housing grooves 34 and 34 of the housing case 26, with a predetermined space from the food passage hole 68. As a result, the food loosening and supplying roller 24 is rotated in the inward rotating direction, whereby food a pushed forward via the food passage hole 68 is supplied from the space to the shutter 25 below while the food a is being loosened by the claws 24a.

The shutter 25 includes a shutter case 69, a pair of opening and closing plates 70 and 70, the above-described driving mechanism 30 for the opening and closing plates 70 and 70.

The shutter case 69 has vertical wall plates 71 and 71 provided to oppose each other at both front and rear sides, and inclined wall plates 72 and 72 gradually inclined inward from an upper side to a lower side, which are provided to oppose each other at both left and right sides, whereby an upper end is formed to be a wide rectangular opening 73 which is longer in a lateral width direction, and a lower end is formed to be a narrow opening 74 in the same shape. The locking portions 72a and 72a protruded outward are provided at the upper ends of the inclined wall plates 72 and 72, and the locking portions 72a and 72a are locked at an inner edge of the opening 53 at the front end of the base rack 27, whereby the shutter case 69 is fitted and fixed to the opening 53 of the base rack 27.

A pair of opening and closing plates 70 and 70 have shaft cylinder portions 70a and 70a integrally formed at base ends of the opening and closing plates 70 and 70, and the shaft cylinder portions 70a and 70a are fitted and fixed onto rotary shafts 75 and 75 placed at substantially central portions at inner sides of the inclined wall plates 72 and 72 of the shutter case 69.

The rotary shafts 75 and 75 are placed to face recessed grooves 72b and 72b provided at substantially central portions of inner sides of the inclined wall plates 72 and 72 of the shutter case 69, with one ends 75a and 75a of them penetrating through the vertical wall plate 71 at a rear side to protrude, and stepped connecting rods 76 and 76 are fitted and fixed onto protrusive ends thereof. Locking levers 77 and 77 are provided integrally at rear ends of the connecting rods 76 and 76 in a state in which the locking levers 77 and 77 oppose each other in such a manner as to be orthogonal to the connecting rods 76 and 76.

Meanwhile, a support plate 78 is vertically provided at a bottom side of the bottom wall 49 of the base rack 27 inside the dishing-up apparatus main body 1, and a motor 79 as the driving mechanism 30 is placed at and fixed to one side of this supporting plate 78. A driving shaft 79a of the motor 79 penetrates the support plate 78 to be protruded to an opposite side, and a circular cam plate 80 and a working plate 81 are fixed to the protruded portion.

The circular cam plate 80 is provided with two cutout step portions 82 and 82 at an interval of 180 degrees by cutout of a half of its circumference. An optical detecting sensor 83 fixed to the support plate 78 is provided at a position corresponding to the cam plate 80 with a light emitting portion at its tip end being faced to the aforementioned cutout step portions 82 and 82.

The working plate 81 has its base end fixed to the driving shaft 79a of the motor 79, and is provided with an engaging pin 84 at an outside of its tip end portion.

A shaft portion 85 is provided directly over the driving shaft 79a of the motor 79 at an upper end of the support plate 78, and a swing arm 86 in a substantially inverted L-shape is swingably supported at its substantially intermediate portion.

A square block 87 is fixed to an inner side of a base end (lower end) of the swing arm 86, and a long hole 88 in which the engaging pin 84 of the working plate 81 is slidably engaged is provided in a center of the square block 87 in a lengthwise direction.

The square block 87 can be integrally formed with the swing arm 86.

Meanwhile, an oblong connecting plate 89 is fixedly provided at a tip end (upper end) of the swing arm 86, and a pair of holding pins 90 and 90 are projectingly provided equidistantly at both ends of a front portion of the connecting plate 89 to be orthogonal to the connecting plate 89. These holding pins 90 and 90 sandwich the locking bars 77 and 77 provided at the connecting rods 76 and 76 of the aforementioned rotary shafts 75 and 75 from both sides. The swing arm 86, the square block 87, the connecting plate 89 and the holding pin 90 can be integrally formed.

As shown in FIG. 1, FIG. 2 and FIG. 13, a plurality of (eight in the example shown in the drawings) measuring buttons 91, each of which is aligned for each target measurement value 92 (80, 100, 150, 180, 200, 250, 350 grams, in the example shown in the drawings), are placed on an upper part of the front plate 5 of the dishing-up apparatus main body 1.

These measuring button 91 are connected respectively to a first input port 93a provided at a CPU control device 93. The CPU control device 93 is connected to the motors 57 and 57 as the driving mechanism 28 through a first output port 93b via a rotation control mechanism 94 for the food feeding screws 23, the CPU control device 93 is connected to the motor 60 as the driving mechanism 29 through a second output port 93c via a rotation control mechanism 95 for the loosening and supplying roller 24, and the CPU control device 93 is further connected to the motor 79 as the driving mechanism 30 through a third output port 93d via an opening and closing control mechanism 96 for the opening and closing plates 70 and 70 in the shutter 25.

A second input port 93e is provided at the CPU control device 93, and the food measuring mechanism 101 is connected to this second input port 93e.

The food measuring mechanism 101 is constructed as follows.

As shown in FIG. 1 to FIG. 3, and FIG. 7, the food measuring mechanism 101 is constructed by a measuring platform 102 and an electronic measuring scale 103, which are provided on an upper portion of the front end of the bottom plate 2 of the dishing-up main body 1.

The measuring platform 102 is located directly under the opening 74 at the lower end of the shutter case 69 in the food supplying mechanism 21 and is placed on a top portion of the electronic measuring scale 103, so that it can measure the weight of the food a, when the food a, which is dropped and supplied from the opening 74, is charged into the container 11 placed on the measuring platform 102.

As the aforementioned container 11, a lunch box, a bowl and the like are used.

Next, an operation of the present invention will be explained.

First, after the lid 9 of the food dishing-up apparatus 1 is opened, and the food a (for example, cooked rice) is supplied into the hopper 22, the lid 9 is closed.

Next, the container 11 is placed on the measuring platform 102 of the food measuring mechanism 101, and the measuring button 91 indicating the desired target measurement value 92 is selected and pressed.

When the measuring button 91 is thus pressed, an electric signal thereof is inputted into the CPU control device 93, and is outputted from the CPU control device 93 to the rotation control mechanism 94 for the food feeding screws 23 and 23, the rotation control mechanism 95 for the food loosening and supplying roller 24, and the opening and closing control mechanism 96 for the shutter 25, respectively, to operate the motors 57, 57, 60 and 79 as the driving mechanisms 28, 29 and 30, respectively.

Thereupon, the driving force of the motors 57 and 57 is transmitted to the rotary shafts 23a and 23a of the food feeding screws 23 and 23 via the gears 62 and 63, and rotates the screws 23 and 23 in the inward rotating direction, respectively, and therefore the cooked rice filled into the housing case 26 from the hopper 22 is gradually moved forward along the housing grooves 34 and 34, and pushed out to a clearance provided at the rear portion of the food loosening and supplying roller 24 via the food passage hole 68 formed between the notches 35 and 35 at the lower end of the hopper 22, and the bottom wall 36 of the housing case 26.

The driving force of the motor 60 is transmitted to the support shaft 44 of the food loosening and supplying roller 24 via the pulley 67, the belt 66, the pulley 67a and the gears 65 and 64, and rotates the food loosening and supplying roller 24 in the clockwise direction shown by the arrow in FIG. 7, and therefore the cooked rice pushed out of the food passage hole 68 is raked and dropped downward. Since a number of claws 24a are provided on the outer periphery of the food loosening and supplying roller 24, the cooked rice is loosened to be discrete and charged into the shutter case 69 of the shutter 21 located under the roller 24.

Since the driving force of the motor 79 is transmitted to the cam plate 80 and the working plate 81 and rotates them in the counterclockwise direction shown by the arrow in FIG. 9, the engaging pin 84 provided on the outer side of the tip end portion of the working plate 81 reciprocatively slides in the long hole 88 provided in the square block 87 along the lengthwise direction thereof, and at the same time, the swing arm 86 provided integrally with the square block 87 swings at a predetermined angle with the shaft portion 85 located substantially at a center thereof as the support point.

Since the oblong connecting plate 89 is fixedly provided at the tip end of the swing arm 86 and a pair of holding pins 90 and 90 are projectingly provided at both ends of this connecting plate 89, the locking bars 77 and 77 held by both the holding pins 90 and 90, respectively, swing at the angle (about 90 degrees) shown in FIG. 10 and FIG. 12, and as a result, the rotary shafts 75 and 75 integrated with the locking levers 77 and 77 are rotated at the same angle, whereby a pair of opening and closing plates 70 and 70 are opened and closed.

The optical detecting sensor 83 has its emitting portion provided to face an outer peripheral portion of the cam plate 80 which is rotating, and therefore when the sensor 83 detects the two cutout step portions 82 and 82 provided at the interval of 180 degrees, the signal is transmitted to the opening and closing control mechanism 96 of the shutter 25, whereby the motor 79, which is rotating, stops its drive. After stopping for a fixed time, the drive of the motor 79 is started, and it is stopped when the sensor 83 detects the cutout step portions 82 and 82 next time. The same operation is repeated thereafter. Thus, the motor 79 is intermittently driven to open and close the opening and closing plates 70 and 70 of the shutter 25 intermittently.

The opening and closing plates 70 and 70 are in an open state during an operation in which the aforesaid food feeding screws 23 and 23 and the food loosening and supplying roller 24 are rotated and the cooked rice is charged into the shutter case 69, and the cooked rice is dropped and filled into the container 11 placed on the measuring platform 102 from the opening 74 at the lower end of the shutter case 69.

When the cooed rice in an amount of desired target measurement value 92 is supplied into the container 11, the electronic measuring scale 103 including the measuring platform 102 detects the weight of the cooked rice. A signal thereof is inputted into the CPU control device 93, then is transmitted to the control mechanisms 94 and 95 from the CPU control device 93 to stop the drive of the motors 57, 57, and 60. As a result, the rotation of the food feeding screws 23 and 23, and the food loosening and supplying roller 24 is stopped to stop charging the cooked rice into the shutter case 69.

Meanwhile, the aforesaid measurement signal is transmitted from the CPU control device 93 to the control mechanism 96 of the shutter 25, whereby drive of the motor 79 is started, and the opening and closing plates 70 and 70 of the shutter 25 are brought into the closed state.

After the cooked rice of a desired weight is dished up into the container 11 as described above, the container 11 is removed from the measuring pedestal 102. Then, the next container 11 is placed on the measuring pedestal 102, and a desired measuring button 91 is selected and pressed. This starts the aforementioned operation again, and the cooked rice of the desired weight is dished up into the container 11, thus making it possible to repeat the same operation thereafter.

As described thus far, the present invention is such that a food supplying mechanism and a food measuring mechanism are placed to oppose each other at an upper and a lower positions of the dishing-up apparatus main body, the food supplying mechanism comprises a hopper, loosening and supplying means for supplying food supplied from the hopper while loosening the food, and a shutter for controlling supply and stop of the food to the measuring mechanism, while the food measuring mechanism comprises a measuring platform and an electronic measuring scale, and the food supplying mechanism and food measuring mechanism are connected via a control device. Consequently, each time the container is placed on the measuring platform, food, especially cooked rice of a desired weight is sufficiently loosened, and thereby can be dished up softly into each container with less measuring error.

Since the dishing-up apparatus main body is provided with measuring buttons and the measuring buttons are connected to the food supplying mechanism via the control device, the cooked rice of a desired weight can be quickly and reliably dished up by only selecting and pressing the button clearly indicating the target measurement value. Since the apparatus is simple in its entire structure, compact and light in weight, and can be manufactured at low cost, it is suitable for use in shops manufacturing and selling lunch, shops manufacturing and selling beef bowls.

What is claimed is:

1. An apparatus for measuring and dishing up food in which a food supplying mechanism and a food measuring mechanism are placed to oppose each other at an upper and a lower positions of the dishing-up apparatus main body,
wherein the food supplying mechanism comprises a hopper, loosening and supplying means for supplying food supplied from the hopper while loosening the food, and a shutter for controlling supply and stop of the food to the measuring mechanism, while the food measuring mechanism comprises a measuring platform and an electronic measuring scale; and
wherein said food supplying mechanism and food measuring mechanism are connected via a control device.

2. The apparatus for measuring and dishing up food according to claim 1, wherein the dishing-up apparatus main body is provided with a plurality of measuring buttons placed in parallel each for each target measurement value, and the measuring buttons are connected to the food supplying mechanism via the control device.
